(19) United States
(12) Patent Application Publication
(10) Pub. No.: US 2026/0243305 A1
(43) Pub. Date: Aug. 20, 2026

(54) BEARING FOR A ROTARY SYSTEM

(71) Applicant: Schaeffler Technologies AG & Co. KG, Herzogenaurach (DE)

(72) Inventors: Dorin Ilie, Rock Hill, SC (US); Perry Hollen, Fort Mill, SC (US); Chris Hutchison, Gastonia, NC (US)

(73) Assignee: Schaeffler Technologies AG & Co. KG, Herzogenaurach (DE)

(21) Appl. No.: 19/058,549

(22) Filed: Feb. 20, 2025

(51) Int. Cl. F16C 33/60; F16C 19/22; F16C 33/78

(52) U.S. Cl. CPC F16C 33/60; F16C 19/22; F16C 33/784; F16C 2202/04

(57) ABSTRACT

A rotary system includes a first component, a second component, wherein relative rotation between the first component and the second component is operable to occur about an axis, and a bearing. The bearing includes a band, a first washer, a second washer, and a plurality of rolling elements. The first washer is operable to move axially relative to the band and rotate relative to the band. The second washer and the band are non-rotatably connected. The first washer is engaged with the first component at a first axial side of the first washer. The second washer is engaged with the second component at a second axial side of the second washer.

### FIELD OF THE DISCLOSURE

The present disclosure generally relates to a rotary system that utilizes a bearing. More specifically, the present disclosure generally relates to a liner hanger of an oil well drilling apparatus that utilizes an axial bearing.

### BACKGROUND OF THE DISCLOSURE

Rotary systems often include bearings.

### SUMMARY OF THE DISCLOSURE

According to a first aspect of the present disclosure, a rotary system includes a first component, a second component, wherein relative rotation between the first component and the second component is operable to occur about an axis, and a bearing. The bearing includes a band that extends axially in a first axial direction from a first axial end of the band to a second axial end of the band and radially outboard from an inner surface of the band to an outer surface of the band. The band includes a collar portion that extends from the second axial end toward the first axial end and a shelf portion that extends from the collar portion toward the first axial end. The shelf portion extends radially inboard from the collar portion, such that the inner surface of the shelf portion of the band is radially-inboard of the inner surface of the collar portion of the band. A first washer extends axially in the first axial direction from a first axial side of the first washer to a second axial side of the first washer and radially outboard from an inner surface of the first washer to an outer surface of the first washer, the outer surface of the first washer having a first portion that extends toward the second axial side of the first washer. A shoulder portion extends radially outboard from the first portion of the outer surface of the first washer, and a second portion that extends from the shoulder portion toward the second axial side of the first washer, wherein a diameter of the inner surface of the band at the collar portion is greater than a diameter of the outer surface of the first washer at the second portion, and a diameter of the inner surface of the band at the shelf portion is greater than a diameter of the outer surface of the first washer at the first portion such that relative rotation between the band and the first washer is allowed. The first washer is positioned relative to the band, such that the first axial side of the first washer is positioned axially beyond the first axial end of the band in a second axial direction opposite the first axial direction and is engaged with the first component. A second washer is in an axially-spaced relationship with the first washer and extends axially in the first axial direction from a first axial side of the second washer to a second axial side of the second washer and radially outboard from an inner surface of the second washer to an outer surface of the second washer. The second washer is press-fit with the band such that the second axial side of the second washer is positioned axially beyond the second axial end of the band in the first axial direction, and the second washer and the band are non-rotatably connected due to engagement between the inner surface of the band at the collar portion and the outer surface of the second washer. The second axial side of the second washer is engaged with the second component. A plurality of rolling elements is disposed axially between the first washer and the second washer and are configured to facilitate relative rotation between the first washer and the non-rotatably connected band and second washer, such that relative rotation between the first component that is engaged with the first washer and the second component that is engaged with second washer is accommodated.

Embodiments of the first aspect of the disclosure can include any one or a combination of the following features:
the plurality of rolling elements is a plurality of full complementary rolling elements;
the rolling elements are cylindrical rolling elements;
the inner surface of the band has a hardness of 58 on the Rockwell C scale;
the inner surface of the band has an arithmetic average surface roughness of about 0.8 micrometers;
a seal is positioned radially between the inner surface of the band at the collar portion and the outer surface of the first washer at the second portion;
the first washer is operable to move axially relative to the band to accommodate tilting of at least one of the plurality of rolling elements relative to the band;
interference between the second axial side of the first washer and at least one of the plurality of rolling elements is configured to bound axial movement of the first washer in the first axial direction, and interference between the shelf portion of the band and the shoulder portion of the outer surface of the first washer is configured to bound axial movement of the first washer in the second axial direction; and
the rotary system comprises a liner hanger.

According to a second aspect of the present disclosure, a bearing for facilitating relative rotation between a first component and a second component about an axis includes a band that extends axially in a first axial direction from a first axial end of the band to a second axial end of the band and radially outboard from an inner surface of the band to an outer surface of the band. The band includes a collar portion that extends from the second axial end toward the first axial end and a shelf portion that extends from the collar portion toward the first axial end, wherein the shelf portion extends radially inboard from the collar portion, such that the inner surface of the shelf portion of the band is radially-inboard of the inner surface of the collar portion of the band. A first washer extends axially in the first axial direction from a first axial side of the first washer to a second axial side of the first washer and radially outboard from an inner surface of the first washer to an outer surface of the first washer. The outer surface of the first washer includes a first portion that extends toward the second axial side of the first washer, a shoulder portion that extends radially outboard from the first portion of the outer surface of the first washer, and a second portion that extends from the shoulder portion toward the second axial side of the first washer. A diameter of the inner surface of the band at the collar portion is greater than a diameter of the outer surface of the first washer at the second portion. A diameter of the inner surface of the band at the shelf portion is greater than a diameter of the outer surface of the first washer at the first portion such that relative rotation between the band and the first washer is allowed. The first washer is positioned relative to the band, such that the first axial side of the first washer is positioned axially beyond the first axial end of the band in a second axial direction opposite the first axial direction. A second washer is in an axially-spaced relationship with the first washer and extends axially in the first axial direction from a first axial side of the second washer to a second axial side of the second washer and radially outboard from an inner surface of the second washer to an outer surface of the second washer. The second washer is press-fit with the band such that the second axial side of the second washer is positioned axially beyond the second axial end of the band in the first axial direction, and the second washer and the band are non-rotatably connected due to engagement between the inner surface of the band at the collar portion and the outer surface of the second washer. A plurality of rolling elements is disposed axially between the first washer and the second washer and is configured to facilitate relative rotation between the first washer and the non-rotatably connected band and the second washer.

Embodiments of the second aspect of the disclosure can include any one or a combination of the following features:
a retention sleeve is disposed radially-inboard of the first washer, the second washer, and the plurality of rolling elements, wherein the retention sleeve limits radially-inboard displacement of the plurality of rolling elements;
the plurality of rolling elements is a plurality of full complementary rolling elements;
the rolling elements are cylindrical rolling elements;
the first washer is operable to move axially relative to the band to accommodate tilting of at least one the plurality of rolling elements relative to the band;
interference between the second axial side of the first washer and at least one of the plurality of rolling elements is configured to bound axial movement of the first washer in the first axial direction, and interference between the shelf portion of the band and the shoulder portion of the outer surface of the first washer is configured to bound axial movement of the first washer in the second axial direction;
the inner surface of the band has a hardness equal to or greater than about 58 on the Rockwell C scale;
the inner surface of the band has an arithmetic average surface roughness equal to or less than about 0.8 micrometers; and
a seal is positioned radially between the inner surface of the band at the collar portion and the outer surface of the first washer at the second portion.

According to a third aspect of the present disclosure, a bearing facilitates relative rotation between a first component and a second component about an axis. A band extends axially in a first axial direction from a first axial end of the band to a second axial end of the band. A first washer is positioned radially-inboard of the band and extends axially-beyond the first axial end of the band in a second axial direction opposite the first axial direction. The first washer is positioned relative to the band, such that axial movement of the first washer relative to the band and relative rotation between the first washer and the band are allowed. A second washer is positioned radially inboard of the band in an axially-spaced relationship with the first washer. The second washer is non-rotatably connected to the band and extends axially beyond the second axial end of the band in the first axial direction. A plurality of rolling elements is disposed axially between the first washer and the second washer and is configured to facilitate relative rotation between the first washer and the non-rotatably connected band and the second washer.

Embodiments of the third aspect of the disclosure can include any one or a combination of the following feature:
the band includes a radially-inboard extending shelf portion that is disposed proximate to the first axial end of the band, and an outer surface of the first washer includes a shoulder portion that is configured to selectively interfere with the shelf portion to limit axial displacement of the first washer relative to the band.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a bearing that includes a band, a first washer, a second washer, and a plurality of rolling elements, according to embodiment;

FIG. 2 is a cutaway view of the bearing of FIG. 1 taken at line II-II, according to one embodiment;

FIG. 3 is an enlarged view of Area III of FIG. 2 that is augmented with a first component of a rotary system and a second component of a rotary system in phantom, according to one embodiment; and

FIG. 4 is cutaway view of a portion of a bearing that includes a seal positioned radially between a first washer of the bearing and a band of the bearing, wherein a retention sleeve is illustrated in phantom, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along an axis about which a component is configured to rotate in operation of the apparatus described herein. Further, the term “radial” and derivatives thereof, such as “radially,” shall be understood in relation to the aforementioned axis. For example, “radially outboard” refers to further away from the axis, while “radially inboard” refers to nearer to the axis. The term “circumferential” and derivatives thereof, such as “circumferentially,” shall be understood in relation to the aforementioned axis as well.

As used herein, “non-rotatably connected” elements shall be understood to refer to elements that are connected such that whenever one of the elements rotates about the axis, all of the elements rotate about the axis at a common rate of rotation, and relative rotation between the elements is restricted

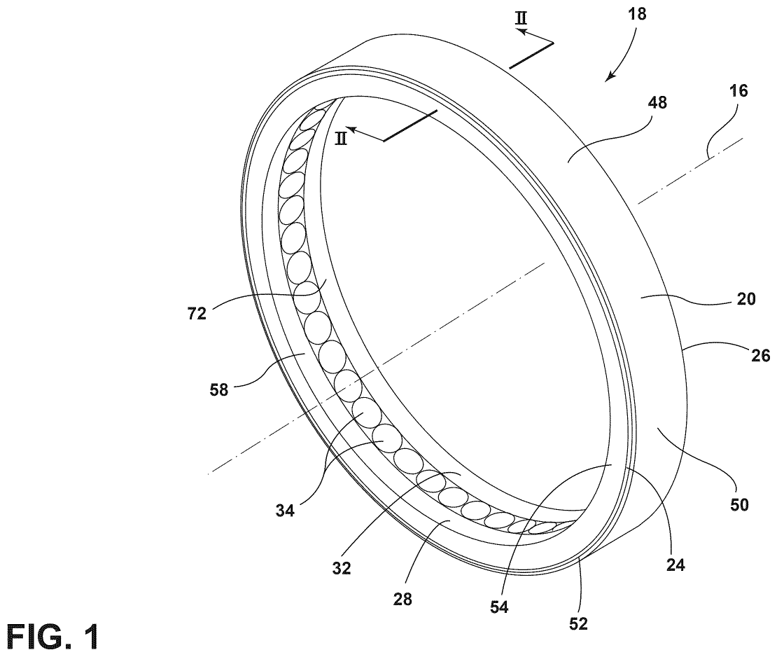

Referring now to FIGS. 1-4, a rotary system 10 includes a first component 12 and a second component 14. Relative rotation between the first component 12 and the second component 14 is operable to occur about an axis 16. The rotary system 10 includes a bearing 18. The bearing 18 is configured to facilitate relative rotation between the first component 12 and the second component 14 about the axis 16. The bearing 18 includes a band 20 that extends axially in a first axial direction 22 from a first axial end 24 of the band 20 to a second axial end 26 of the band 20. A first washer 28 is positioned radially inboard of the band 20 and extends axially beyond the first axial end 24 of the band 20 in a second axial direction 30 that is opposite the first axial direction 22. The first washer 28 is positioned relative to the band 20, such that axial movement of the first washer 28 relative to the band 20 and relative rotation between the first washer 28 and the band 20 are allowed. A second washer 32 is positioned radially inboard of the band 20 in an axially-spaced relationship with the first washer 28. The second washer 32 is non-rotatably connected to the band 20, and the second washer 32 extends axially beyond the second axial end 26 of the band 20 in the first axial direction 22. A plurality of rolling elements 34 are disposed axially between the first washer 28 and the second washer 32 and are configured to facilitate relative rotation between the first washer 28 and the non-rotatably connected band 20 and the second washer 32. The first component 12 is engaged with the first washer 28, and the second component 14 is engaged with the second washer 32, such that the bearing 18 facilitates relative rotation between the first component 12 and the second component 14 about the axis 16.

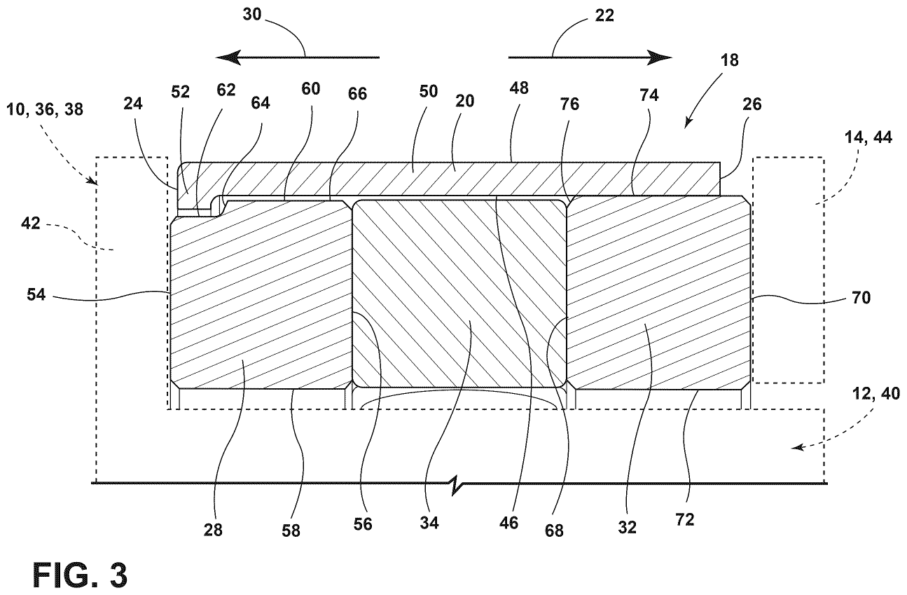

Referring now to FIGS. 1-4, the rotary system 10 includes the first component 12 and the second component 14. The first component 12 and the second component 14 are configured to undergo relative rotation with respect to each other about the axis 16. In other words, the first component 12 may be configured to rotate about the axis 16 relative to the second component 14 and/or the second component 14 may be configured to rotate relative to the first component 12 about the axis 16. It is contemplated that the rotary system 10 may be one or more of a variety of types of rotary systems. In an exemplary implementation, the rotary system 10 may be an oil well drilling apparatus 36 that includes a liner hanger 38. The liner hanger 38 may be configured to hang a liner relative to a casing in the process of tapping an oil well. As such, in some implementations, the first component 12 may be a component of the oil well drilling apparatus 36 and/or the liner hanger 38, and the second component 14 may be another component of the oil well drilling apparatus 36 and/or the liner hanger 38. As illustrated in FIG. 3, the first component 12 is a mandrel 40 of the oil well drilling apparatus 36 that extends through a central aperture defined by the bearing 18. The mandrel 40 includes a flange 42 that extends radially outboard to engage with the first washer 28 of the bearing 18, as described further herein. In the illustrated embodiment, the second component 14 is a housing 44 of the liner hanger 38 of the oil well drilling apparatus 36. The housing 44 is engaged with the second washer 32 of the bearing 18. The mandrel 40 can be configured to rotate about the axis 16 relative to the generally rotationally-stationary second washer 32 in operation of the oil well drilling apparatus 36.

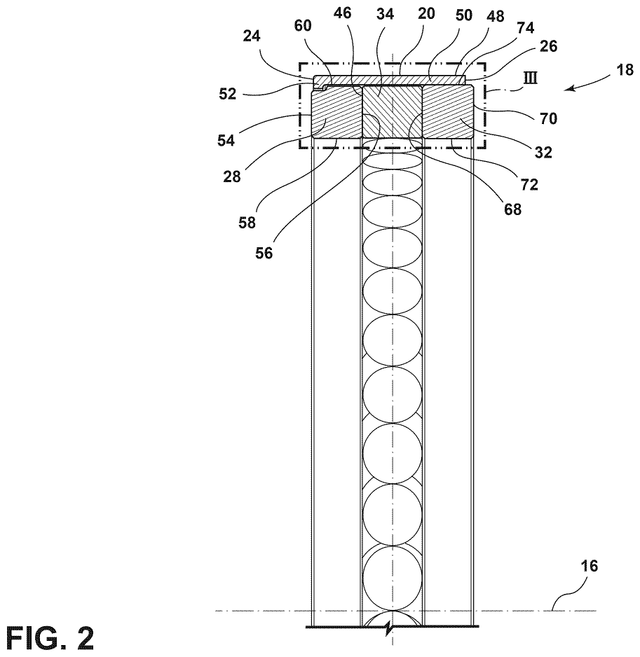

Referring still to FIGS. 1-4, the bearing 18 is illustrated. The bearing 18 includes the band 20 that extends axially in the first axial direction 22 from the first axial end 24 of the band 20 to the second axial end 26 of the band 20. The band 20 extends radially outboard from an inner surface 46 of the band 20 to an outer surface 48 of the band 20. As illustrated in FIGS. 2-4, the band 20 includes a collar portion 50 and a shelf portion 52. The collar portion 50 extends from the second axial end 26 of the band 20 toward the first axial end 24 of the band 20. The shelf portion 52 extends from the collar portion 50 toward the first axial end 24 and extends radially inboard from the collar portion 50. As illustrated in FIG. 3, the shelf portion 52 extends radially inboard from the collar portion 50, such that the inner surface 46 of the shelf portion 52 of the band 20 is radially inboard of the inner surface 46 of the collar portion 50 of the band 20. The shelf portion 52 of the band 20 may be configured to interfere with a portion of the first washer 28 to limit axial movement of the first washer 28, as described further herein.

In various implementations, the band 20 can be formed of metal, and at least a portion of the metal band can be hardened and/or polished. In some examples, at least the inner surface 46 of the band 20 can be hardened and/or polished. The inner surface 46 of the band 20 can have a hardness that is greater than or equal to about 58 on the Rockwell C scale, in some embodiments. The inner surface 46 of the band 20 can have an arithmetic average surface roughness that is equal to or less than about 0.8 micrometers. In an exemplary embodiment, the inner surface 46 of the band 20 has a hardness of about 58 on the Rockwell C scale, and an arithmetic average surface roughness of about 0.8 micrometers. The inner surface 46 of the band 20 being hardened and/or polished can advantageously allow for effective press-fitting of the band 20 and the second washer 32 and can aid in preventing deformation of the band 20 due to forcible interference between the inner surface 46 of the band 20 and the plurality of rolling elements 34 caused by axial loads endured by the bearing 18, as described further herein.

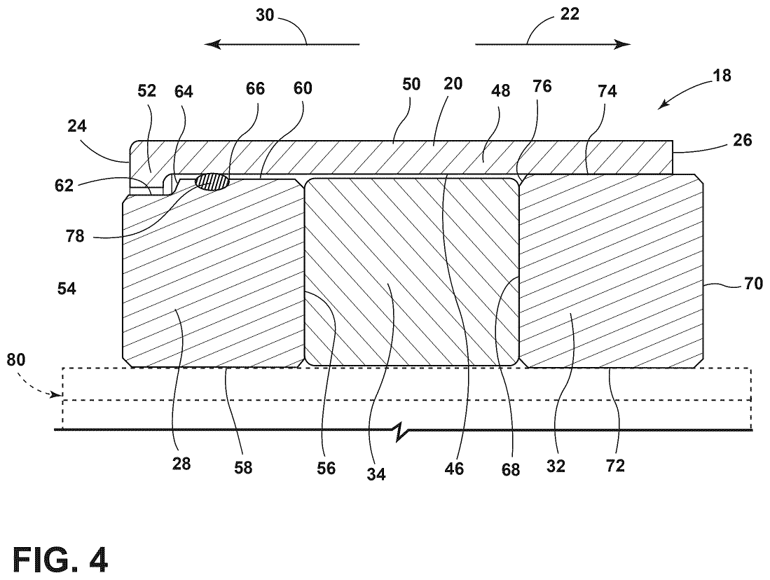

Referring now to FIGS. 1-4, the bearing 18 includes the first washer 28. The first washer 28 extends axially in the first axial direction 22 from a first axial side 54 of the first washer 28 to a second axial side 56 of the first washer 28. The first washer 28 extends radially outboard from an inner surface 58 of the first washer 28 to an outer surface 60 of the first washer 28. As illustrated in FIGS. 3 and 4, the outer surface 60 of the first washer 28 includes a first portion 62, a shoulder portion 64, and a second portion 66. The first portion 62 extends toward the second axial side 56 of the first washer 28. The shoulder portion 64 extends radially outboard from the first portion 62 of the outer surface 60 of the first washer 28. The second portion 66 extends from the shoulder portion 64 toward the second axial side 56 of the first washer 28.

In the embodiment illustrated in FIG. 3, a diameter of the inner surface 46 of the band 20 at the collar portion 50 is greater than a diameter of the outer surface 60 of the first washer 28 at the second portion 66. Further, a diameter of the inner surface 46 of the band 20 at the shelf portion 52 is greater than a diameter of the outer surface 60 of the first washer 28 at the first portion 62. As such, relative rotation between the band 20 and the first washer 28 is allowed in operation of the bearing 18. As illustrated in FIG. 3, the shoulder portion 64 of the outer surface 60 of the first washer 28 is radially-aligned and axially-offset from the collar portion 50 of the band 20. In various implementations, this axial offset allows for some axial movement of the first washer 28 relative the band 20, and the radial alignment ensures that interference between the shelf portion 52 of the band 20 and the shoulder portion 64 of the outer surface 60 of the first washer 28 bounds axial movement of the first washer 28 in the second axial direction 30. As such, the shoulder portion 64 is configured to selectively interfere with the shelf portion 52 to limit axial displacement of the first washer 28 relative to the band 20. As illustrated in FIGS. 2-4, the first washer 28 is positioned relative to the band 20, such that the first axial side 54 of the first washer 28 is positioned axially beyond the first axial end 24 of the band 20 in the second axial direction 30. The first axial side 54 of the first washer 28 extending beyond the band 20 in this way allows for engagement between the first component 12 of the rotary system 10 and the first axial side 54 of the first washer 28, as illustrated in FIG. 3.

Referring now to FIGS. 1-4, the second washer 32 is positioned radially inboard of the band 20 and is in an axially-spaced relationship with the first washer 28. The second washer 32 extends axially from a first axial side 68 of the second washer 32 to a second axial side 70 of the second washer 32 in the first axial direction 22. Further, the second washer 32 extends radially outboard from an inner surface 72 of the second washer 32 to an outer surface 74 of the second washer 32. The second washer 32 can be non-rotatably connected to the band 20. In various implementations, the second washer 32 and the band 20 are press fit together to form the non-rotatable connection. Prior to press-fitting, the outer diameter of the outer surface 74 of the second washer 32 can be slightly greater than the diameter of the inner surface 46 of the band 20 at the collar portion 50. The second washer 32 can have a rounded or chamfered corner 76 adjacent to the outer surface 74 of the second washer 32 that allows for initial partial insertion of the second washer 32 into the band 20, in some embodiments, prior to an axial force being applied to accomplish the press fit. The polished surface of the inner surface 46 of the band 20 can aid in facilitating the press-fitting of the band 20 and the second washer 32.

In various embodiments, the second washer 32 is positioned relative to the band 20, such that the second axial side 70 of the second washer 32 extends axially beyond the second axial end 26 of the band 20 in the first axial direction 22. For example, in the embodiments illustrated in FIGS. 3 and 4, the second washer 32 and the band 20 are non-rotatably connected due to engagement between the inner surface 46 of the band 20 at the collar portion 50 and the outer surface 74 of the second washer 32, and the second axial side 70 of the second washer 32 extends axially beyond the second axial end 26 of the band 20 in the first axial direction 22. The second washer 32 extending axially beyond the band 20 in this way may advantageously allow for engagement between the second component 14 of the rotary system 10 and the second axial side 70 of the second washer 32, as illustrated in FIG. 3.

Referring again to FIGS. 1-4, the bearing 18 includes the plurality of rolling elements 34. In some implementations, the plurality of rolling elements 34 is a plurality of full complement rolling elements 34. In other words, the bearing 18 can be constructed without a cage or retainer, and the rolling elements 34 fill the circumference of the race to maximize load-carrying capacity. In some embodiments, the rolling elements 34 are cylindrical rolling elements 34. A variety of shapes and/or types of rolling elements are contemplated (e.g., ball, frustoconical, etc.). In the embodiments illustrated in FIGS. 1-4, the plurality of rolling elements 34 is a plurality of full complement rolling elements 34, and each rolling element 34 is a cylindrical rolling element.

In various implementations, selective interference between at least one of the plurality of rolling elements 34 and the first washer 28 bounds axial movement of the first washer 28 in the first axial direction 22. In some embodiments, in operation of the rotary system 10, wherein high axial loads are incurred by the bearing 18, the first washer 28 is operable to move axially relative to the band 20 to accommodate tilting of at least one of the plurality of rolling elements 34 relative to the band 20. The rolling elements 34 tilting relative to the band 20 due to high axial loads during operation of the bearing 18 can result in forcible interference between the inner surface 46 of the band 20 and the tilted rolling elements 34. As such, it is advantageous that the inner surface 46 of the band 20 is hardened, as described herein, such that severe deformation and/or wear on the band 20 (e.g., grooving) is avoided.

Referring now to FIG. 4, in some implementations, the bearing 18 can include a seal 78. The seal 78 can be a ring (e.g., O-ring) in some embodiments. As illustrated in FIG. 4 the seal 78 is positioned radially between the inner surface 46 of the band 20 at the collar portion 50 and the outer surface 60 of the first washer 28 at the second portion 66. The seal 78 may be configured to retain lubricant, such as grease within the bearing 18 during operation of the rotary system 10.

Referring still to FIG. 4, in some implementations, the bearing 18 can include a retention sleeve 80. As illustrated in FIG. 4, the retention sleeve 80 is disposed radially-inboard of the first washer 28, the second washer 32, and the plurality of rolling elements 34. The retention sleeve 80 is configured to limit radially-inboard displacement of the plurality of rolling elements 34. For example, in an exemplary embodiment of the bearing 18 wherein the bearing 18 is not yet implemented into the rotary system 10, the cylindrical rolling elements 34 are disposed axially between the first and second washers 28, 32, and are susceptible to falling out of the bearing 18 in the radially-inboard direction. As such, the retention sleeve 80, which extends through the central aperture defined by the bearing 18, acts as a guard against radially-inboard displacement of the cylindrical rolling elements 34 to retain them in the bearing 18. The bearing 18 may be fitted with the retention sleeve 80 prior to implementation of the bearing 18 into the rotary system 10 (e.g., during shipping and handling), and then the retention sleeve 80 may be removed from the bearing 18 when the bearing 18 is implemented into the rotary system 10.

It is to be understood that variations and modifications can be made on the aforementioned structure without departing from the concepts of the present disclosure, and further it is to be understood that such concepts are intended to be covered by the following claims unless these claims by their language expressly state otherwise.

List of Reference Numerals

| | | |
|---|---|---|
| 16 | axis | |
| 18 | bearing | |
| 20 | band | |
| 22 | first axial direction | |
| 24 | first axial end | |
| 26 | second axial end | |
| 28 | first washer | |
| 30 | second axial direction | |
| 32 | second washer | |
| 34 | rolling elements | |
| 36 | oil well drilling apparatus | |
| 38 | liner hanger | |
| 40 | mandrel | |
| 42 | flange | |
| 44 | housing | |
| 46 | inner surface | of band |
| 48 | outer surface | of band |
| 50 | collar portion | |
| 52 | shelf portion | |
| 54 | first axial side | of first washer |
| 56 | second axial side | of first washer |
| 58 | inner surface | of first washer |
| 60 | outer surface | of first washer |
| 62 | first portion | |
| 64 | shoulder portion | |
| 66 | second portion | |
| 68 | first axial side | of second washer |
| 70 | second axial side | of second washer |
| 72 | inner surface | of second washer |
| 74 | outer surface | of second washer |
| 76 | corner | |
| 78 | seal | |
| 80 | retention sleeve | |

What is claimed is:

1. A rotary system, comprising:
a first component;
a second component, wherein relative rotation between the first component and the second component is operable to occur about an axis; and
a bearing, comprising:
a band that extends axially in a first axial direction from a first axial end of the band to a second axial end of the band and radially outboard from an inner surface of the band to an outer surface of the band, the band having a collar portion that extends from the second axial end toward the first axial end and a shelf portion that extends from the collar portion toward the first axial end, wherein the shelf portion extends radially inboard from the collar portion, such that the inner surface of the shelf portion of the band is radially-inboard of the inner surface of the collar portion of the band;
a first washer that extends axially in the first axial direction from a first axial side of the first washer to a second axial side of the first washer and radially outboard from an inner surface of the first washer to an outer surface of the first washer, the outer surface of the first washer having a first portion that extends toward the second axial side of the first washer, a shoulder portion that extends radially outboard from the first portion of the outer surface of the first washer, and a second portion that extends from the shoulder portion toward the second axial side of the first washer, wherein a diameter of the inner surface of the band at the collar portion is greater than a diameter of the outer surface of the first washer at the second portion, and a diameter of the inner surface of the band at the shelf portion is greater than a diameter of the outer surface of the first washer at the first portion such that relative rotation between the band and the first washer is allowed, and wherein the first washer is positioned relative to the band, such that the first axial side of the first washer is positioned axially beyond the first axial end of the band in a second axial direction opposite the first axial direction and is engaged with the first component;
a second washer that is in an axially-spaced relationship with the first washer and that extends axially in the first axial direction from a first axial side of the second washer to a second axial side of the second washer and radially outboard from an inner surface of the second washer to an outer surface of the second washer, the second washer being press-fit with the band such that the second axial side of the second washer is positioned axially beyond the second axial end of the band in the first axial direction, and the second washer and the band are non-rotatably connected due to engagement between the inner surface of the band at the collar portion and the outer surface of the second washer, wherein the second axial side of the second washer is engaged with the second component; and
a plurality of rolling elements disposed axially between the first washer and the second washer and configured to facilitate relative rotation between the first washer and the non-rotatably connected band and second washer, such that relative rotation between the first component that is engaged with the first washer and the second component that is engaged with second washer is accommodated.

2. The rotary system of claim 1, wherein the plurality of rolling elements is a plurality of full complementary rolling elements.

3. The rotary system of claim 2, wherein the rolling elements are cylindrical rolling elements.

4. The rotary system of claim 1, wherein the inner surface of the band has a hardness of 58 on the Rockwell C scale.

5. The rotary system of claim 4, wherein the inner surface of the band has an arithmetic average surface roughness of about 0.8 micrometers.

6. The rotary system of claim 1, further comprising:
a seal positioned radially between the inner surface of the band at the collar portion and the outer surface of the first washer at the second portion.

7. The rotary system of claim 1, wherein the first washer is operable to move axially relative to the band to accommodate tilting of at least one of the plurality of rolling elements relative to the band.

8. The rotary system of claim 7, wherein interference between the second axial side of the first washer and at least one of the plurality of rolling elements is configured to bound axial movement of the first washer in the first axial direction, and interference between the shelf portion of the band and the shoulder portion of the outer surface of the first washer is configured to bound axial movement of the first washer in the second axial direction.

9. The rotary system of claim 1, wherein the rotary system comprises a liner hanger.

10. A bearing for facilitating relative rotation between a first component and a second component about an axis, comprising:
a band that extends axially in a first axial direction from a first axial end of the band to a second axial end of the band and radially outboard from an inner surface of the band to an outer surface of the band, the band having a collar portion that extends from the second axial end toward the first axial end and a shelf portion that extends from the collar portion toward the first axial end, wherein the shelf portion extends radially inboard from the collar portion, such that the inner surface of the shelf portion of the band is radially-inboard of the inner surface of the collar portion of the band;
a first washer that extends axially in the first axial direction from a first axial side of the first washer to a second axial side of the first washer and radially outboard from an inner surface of the first washer to an outer surface of the first washer, the outer surface of the first washer having a first portion that extends toward the second axial side of the first washer, a shoulder portion that extends radially outboard from the first portion of the outer surface of the first washer, and a second portion that extends from the shoulder portion toward the second axial side of the first washer, wherein a diameter of the inner surface of the band at the collar portion is greater than a diameter of the outer surface of the first washer at the second portion, and a diameter of the inner surface of the band at the shelf portion is greater than a diameter of the outer surface of the first washer at the first portion such that relative rotation between the band and the first washer is allowed, and wherein the first washer is positioned relative to the band, such that the first axial side of the first washer is positioned axially beyond the first axial end of the band in a second axial direction opposite the first axial direction;
a second washer that is in an axially-spaced relationship with the first washer and that extends axially in the first axial direction from a first axial side of the second washer to a second axial side of the second washer and radially outboard from an inner surface of the second washer to an outer surface of the second washer, the second washer being press-fit with the band such that the second axial side of the second washer is positioned axially beyond the second axial end of the band in the first axial direction, and the second washer and the band are non-rotatably connected due to engagement between the inner surface of the band at the collar portion and the outer surface of the second washer; and
a plurality of rolling elements disposed axially between the first washer and the second washer and configured to facilitate relative rotation between the first washer and the non-rotatably connected band and the second washer.

11. The bearing of claim 10, further comprising:
a retention sleeve disposed radially-inboard of the first washer, the second washer, and the plurality of rolling elements, wherein the retention sleeve limits radially-inboard displacement of the plurality of rolling elements.

12. The bearing of claim 10, wherein the plurality of rolling elements is a plurality of full complementary rolling elements.

13. The bearing of claim 10, wherein the rolling elements are cylindrical rolling elements.

14. The bearing of claim 10, wherein the first washer is operable to move axially relative to the band to accommodate tilting of at least one the plurality of rolling elements relative to the band.

15. The bearing of claim 14, wherein interference between the second axial side of the first washer and at least one of the plurality of rolling elements is configured to bound axial movement of the first washer in the first axial direction, and interference between the shelf portion of the band and the shoulder portion of the outer surface of the first washer is configured to bound axial movement of the first washer in the second axial direction.

16. The bearing of claim 10, wherein the inner surface of the band has a hardness equal to or greater than about 58 on the Rockwell C scale.

17. The bearing of claim 16, wherein the inner surface of the band has an arithmetic average surface roughness equal to or less than about 0.8 micrometers.

18. The bearing of claim 10, further comprising:
a seal positioned radially between the inner surface of the band at the collar portion and the outer surface of the first washer at the second portion.

19. A bearing for facilitating relative rotation between a first component and a second component about an axis, comprising:
a band that extends axially in a first axial direction from a first axial end of the band to a second axial end of the band;
a first washer positioned radially-inboard of the band and extending axially-beyond the first axial end of the band in a second axial direction opposite the first axial direction, wherein the first washer is positioned relative to the band, such that axial movement of the first washer relative to the band and relative rotation between the first washer and the band are allowed;
a second washer positioned radially inboard of the band in an axially-spaced relationship with the first washer, wherein the second washer is non-rotatably connected to the band, and the second washer extends axially beyond the second axial end of the band in the first axial direction; and
a plurality of rolling elements disposed axially between the first washer and the second washer and configured to facilitate relative rotation between the first washer and the non-rotatably connected band and the second washer.

20. The bearing of claim 19, wherein the band includes a radially-inboard extending shelf portion that is disposed proximate to the first axial end of the band, and an outer surface of the first washer includes a shoulder portion that is configured to selectively interfere with the shelf portion to limit axial displacement of the first washer relative to the band.
